(19) United States
(12) Patent Application Publication
(10) Pub. No.: US 2018/0066536 A1
(43) Pub. Date: Mar. 8, 2018

(54) COMPRESSOR STAGE

(71) Applicant: SAFRAN AIRCRAFT ENGINES, Paris (FR)

(72) Inventors: Christophe SCHOLTES, Moissy-Cramayel CEDEX (FR); Thomas Nolwenn Emmanuel DELAHAYE, Moissy-Cramayel CEDEX (FR); Armel Marie Jean Pascal TOUYERAS, Moissy-Cramayel CEDEX (FR)

(73) Assignee: SAFRAN AIRCRAFT ENGINES, Paris (FR)

(21) Appl. No.: 15/561,192

(22) PCT Filed: Mar. 25, 2016
(86) PCT No.: PCT/FR2016/050692

§ 371 Date: Sep. 25, 2017

(30) Foreign Application Priority Data
Mar. 26, 2015 (FR) 1552537

(51) Int. Cl. F01D 25/02; F02C 7/047

(52) U.S. Cl. CPC F01D 25/02; F02C 7/047

(57) ABSTRACT

The invention relates to the field of compressors, and specifically a compressor stage (100) comprising at least a casing (101) delimiting an air passage (2), a stator (102) comprising a plurality of guide vanes (103) arranged radially around a central axis (X) in the air passage (2), and a rotor (104) suitable for rotating about the central axis (X) relative to the stator (102) and comprising a plurality of blades (105) arranged radially around the central axis (X) in the air passage (2) downstream from the guide vanes (103). Each blade (105) of the rotor (104) extends from a blade root (105a) to a blade tip (105b) further away from the central axis (X) than the blade root (105a) and presents radial clearance (j) between the blade tip (105b) and the casing (101). In order to avoid ice forming on the guide vanes, and also in order to avoid blade tip clearance vortices, at least one of said guide vanes (103) includes an internal cavity (106) with a hot air inlet (107) for deicing the guide vane (103), and the internal cavity (106) presents a first outlet passage (108) towards a trailing edge (112) of the guide vane (103) for injecting an air jet (114) into a boundary layer (115) adjacent to the casing (101) upstream from the blades (105) of the rotor (104).

### BACKGROUND OF THE INVENTION

The present invention relates to the field of turbomachines and more particularly to that of compressors.

The term “turbomachine” is used in the present context to designate any machine in which energy can be transferred between a fluid flow and at least one set of blades, such as for example a compressor, a pump, a turbine, or indeed a combination of at least two of these. The terms “upstream” and “downstream” are defined relative to the normal flow direction of fluid through the turbomachine.

Turbomachines include in particular turbine heat engines for converting the chemical energy of fuel into thermal energy by burning the fuel, and then converting this thermal energy into mechanical energy by expanding a working fluid heated by burning the fuel.

In internal combustion turbine heat engines, such as gas turbines, turboshaft engines, turbojets, turbofans, or turboprops, combustion takes place directly in the working fluid, which is typically air. Typically such internal combustion turbine engines have at least one compressor upstream from the combustion chamber and at least one turbine downstream from the combustion chamber, which turbine is coupled to the compressor in order to drive it by partial expansion of the working fluid heated by the combustion of the fuel. Normally, a remainder of the thermal energy of the working fluid is then recovered as mechanical energy by a reaction nozzle and/or by at least one additional turbine coupled to a drive shaft.

Among compressors, there are included in particular axial compressors in which the flow direction of the working fluid is substantially parallel to a central axis of rotation of at least one rotary blade set (or rotor) serving to transfer energy to the working fluid in order to compress it. In an axial compressor stage, the rotor typically has a plurality of blades that are arranged radially, each blade of the rotor extending from a blade root to a blade tip that is further from the central axis than the blade root and that presents radial clearance between the blade tip and a casing that defines a passage for passing the flow of working fluid. The radial clearance is normally necessary for preventing contact between the blade tips and the casing, where such contact would not only give rise to losses by friction, but would also run the risk of damaging the casing and/or the rotor. Nevertheless, this clearance allows a vortex to arise at the blade tip, which vortex not only significantly degrades the efficiency of the compressor stage, but is also harmful for the stability margin of the rotor, in particular in the first compressor stages.

In order to blow away these tip clearance vortices, proposals have already been made in the prior art, e.g. in patents U.S. Pat. No. 8,182,209 and U.S. Pat. No. 8,882,443, and also in international patent application WO 2011/023891, to inject a jet of air into a boundary layer adjacent to the casing and upstream from the rotor blades in such a manner as to energize this boundary layer and increase the stability of the flow at the blade tips of the rotor. The amplitude and the persistence of clearance vortices can thus be greatly diminished locally, and the stability margin and the efficiency of the compressor stage can be significantly improved. Nevertheless, the air that is injected in this way into the boundary layer is normally taken downstream from the compressor stage, thereby involving a performance penalty, and also additional mechanical complexity. Furthermore, the air is consequently hotter than the boundary layer into which it is injected, which limits its effectiveness in energizing the boundary layer.

At the same time, such a compressor stage normally also includes a stator comprising a plurality of guide vanes arranged radially around a central axis in the air passage upstream from the rotor. These guide vanes, particularly in a first compressor stage of a turboprop, a turboshaft engine, or a single-flow turbojet, can present a risk of icing. In order to limit this risk of icing, electrical devices have been proposed, together with variations in the angle of attack of the guide vanes. Nevertheless, such devices also increase the complexity and the weight of the compressor stage, or they have a negative impact on its performance.

### OBJECT AND SUMMARY OF THE INVENTION

The present disclosure seeks to remedy such drawbacks by proposing a compressor stage with deicing of the guide vanes and with a greater stability margin, but of limited complexity. This compressor stage may comprise at least a casing delimiting an air passage, a stator comprising a plurality of guide vanes arranged radially around a central axis in the air passage, and a rotor suitable for rotating about the central axis relative to the stator and comprising a plurality of blades arranged radially around the central axis in the air passage downstream from the guide vanes, each blade of the rotor extending from a blade root to a blade tip further away from the central axis than the blade root and presenting radial clearance between the blade tip and the casing. The compressor stage may in particular be an axial stage, even though the invention could optionally also be applied to a stage of the type known as radial or centrifugal.

In at least one embodiment, the looked-for object is achieved by the fact that at least one of said guide vanes includes an internal cavity with a hot air inlet for deicing the guide vane, and in that the internal cavity presents a first outlet passage towards a trailing edge of the guide vane for injecting an air jet into a boundary layer adjacent to the casing upstream from the blades of the rotor.

By means of these provisions, it is possible to ensure firstly that the guide vane is deiced, and secondly to inject a jet of air that has been cooled inside the internal cavity of the vane and that is therefore denser than it would be if it were reinjected without a deicing circuit into the boundary layer in order to blow away tip clearance vortices downstream and thus increase the stability margin and the efficiency of the compressor.

In order to direct the air jet towards the boundary layer, said first outlet passage may be delimited towards the central axis and in an axial and radial plane by a surface that converges downstream towards the casing. In particular, this surface may be curved and convex in the axial and radial plane in order to give greater aerodynamic efficiency, however it could alternatively be straight.

Furthermore, in order to follow the outline of the casing, said first outlet passage may be delimited, away from the central axis and in an axial and radial plane, by a surface that presents, relative to an axial direction, an angle of inclination in the range 0° to 30° towards the central axis downstream.

In particular, said first outlet passage may converge downstream, thus forming a converging nozzle for accelerating the air jet. In an axial and radial plane, said first outlet passage may in particular present an angle of convergence in the range 10° to 60°.

For greater efficiency, said first outlet passage may open out in a slot in an outside surface of the guide vane. This slot may present a bottom edge lying in the range 80% to 95% of a passage height and/or a top edge lying in the range 90% to 100% of the passage height. In this context, the term “passage height” means the distance in a radial direction from an inside edge of the air passage beside the central axis to an outside edge of the air passage beside the casing, at the level of the slot, and the positions of the bottom edge and of the top edge of the slot are measured in an outwards radial direction from the bottom edge of the air passage.

To facilitate the provision of hot air, the hot air inlet may in particular be situated radially towards the outside relative to the internal cavity. Under such circumstances, in order to provide better heat exchange, the internal cavity may present a radial partition situated between the inlet and the first outlet passage and open at an end remote from the air inlet. The hot air therefore follows a serpentine path, thereby releasing more heat in the guide vane so as to provide better deicing and so as to be injected at a lower temperature into the boundary layer.

In order to enable a larger flow rate of air for deicing, the internal cavity may present at least one other outlet passage opening out separately from the first outlet passage in the trailing edge of the guide vane in a position that is closer to the central axis than is the first outlet passage. Nevertheless, the first outlet passage may present a cross-section that is greater than the other outlet passage.

In order to increase the efficiency of the axial compressor stage at a plurality of speeds, the guide vanes may be of variable angle of incidence.

The present disclosure also relates to a compressor having such an axial compressor stage, in particular as its first stage, and also to a turbomachine, in particular an internal combustion turbine engine and more particularly a turboprop, although it is also possible to envisage a turboshaft engine, a turbojet, or a gas turbine, amongst others, including such a compressor stage.

The present disclosure also relates to a method of eliminating blade tip clearance vortices from such a compressor stage, wherein a jet of air that has flowed through the internal cavity of the guide vane in order to deice it is injected upstream from the blades of the rotor and through the first outlet passage into a boundary layer adjacent to the casing upstream from the blades of the rotor and through which the blade tips pass, for the purpose of energizing the boundary layer.

### BRIEF DESCRIPTION OF THE DRAWINGS

The invention can be well understood and its advantages appear better on reading the following detailed description of embodiments given as non-limiting examples. The description refers to the accompanying drawings, in which:

FIG. 1 is a diagrammatic longitudinal section view of a turboprop with a multistage compressor;

FIG. 2 is a diagrammatic view of a first stage of the FIG. 1 turboprop compressor in a first embodiment of the invention;

FIG. 3 is a diagram showing how an air jet injected into the boundary layer adjacent to the casing upstream from the rotor has an effect on the effective angle of incidence at the tip of the rotor blade; and

FIG. 4 is a diagrammatic view of a compressor first stage in a second embodiment of the invention.

### DETAILED DESCRIPTION OF THE INVENTION

FIG. 1 shows a turboprop 1 comprising, in the flow direction of air in the air passage 2: a multistage compressor 4; a combustion chamber 5; a first turbine 6 connected to the multistage compressor 4 by a first rotary shaft 7; and a second turbine 8 or free turbine coupled to a second rotary shaft 9, or outlet rotary shaft, that may serve in particular to drive a propeller 10 for propelling a vehicle such as an aircraft. The compressor 4, the combustion chamber 5, and the turbine 6 form an assembly which is generally referred to as a “gas generator” and that is to be found in most internal combustion turbine engines, including turboshaft engines, turbojets, turbofans, and gas turbines.

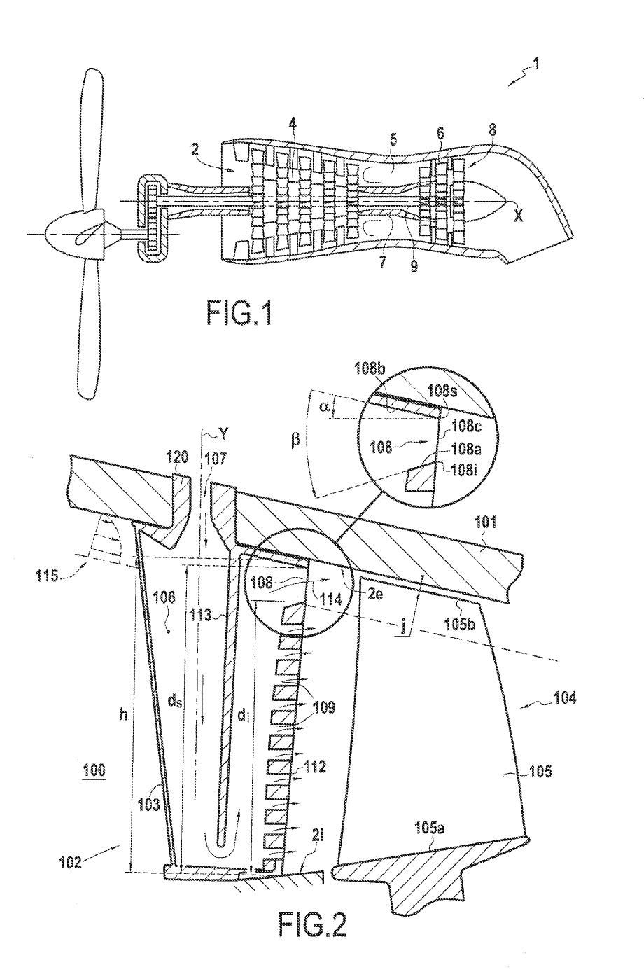

FIG. 2 shows an axial first stage 100 of the compressor 4. This axial compressor stage 100 has a casing 101 delimiting the air passage 2, a stator 102 with a plurality of guide vanes 103 arranged radially around a central axis X in the air passage 2, and a rotor 104 suitable for rotating about the central axis X with the rotary shaft 7, and comprising a plurality of blades 105 arranged radially around the central axis X downstream from the guide vanes 103 in the air passage 2.

Each blade 105 of the rotor 104 extends radially from a blade root 105a to a blade tip 105b in the proximity of the casing 101. Clearance j lies between the blade tip 105b and the casing 101 in order to prevent them coming into contact. Nevertheless, leaks from the pressure side to the suction side around each blade 105 through this clearance j reduce the margin of stability and the efficiency of this first stage 100 of the compressor 4. Furthermore, these leaks give rise to vortices that can propagate downstream from the first compressor 4, generating losses of efficiency and additional vibration in the other stages.

Each vane 103 of the stator 102 is connected to the casing 101 by a pivot 120 that enables it to pivot about a radial axis Y in order to vary the angle of incidence of the vane 103 relative to the flow in the air passage. In addition, in the embodiment shown, each vane 103 is hollow, having an internal cavity 106 connected to a source of hot air via an inlet 107 in the pivot 120. The internal cavity 106 also presents a plurality of outlet passages 108, 109 leading to slots 110, 111 in the trailing edge 112 of the vane 103 so as to enable hot air to flow through the internal cavity 106 from the inlet 107 towards the outlet slots 110, 111. Furthermore, the internal cavity 106 also presents a rib 113 forming a radial partition occupying part of the cavity 106 between the inlet 107 and the outlet passages 108, 109, which open at the end remote from the inlet 107 in a radial direction. Thus, the flow of hot air through the internal cavity 106 follows a serpentine path, with a first segment in which the air flows substantially radially from the outside towards the inside, and a second segment in which the air flows in a substantially radial direction from the inside towards the outside, with a bend between the two segments through the opening in the rib 113. Thus, the rib 113 lengthens the path of the hot air through the cavity 106, thus maximizing the exchange of heat between this hot air and the vane 103.

Furthermore, among the outlet passages 108, 109, the passage 108 that is closest to the casing 101 presents a greater flow section that is than the other passages, and it presents a special shape. More particularly, this passage 108 converges going downstream, thereby forming a convergent nozzle accelerating the outlet flow of air so as to form an air jet 114. At its radially inner side, i.e. towards the central axis X, the passage 108 is delimited by a wall 108a that converges downstream towards the casing 101 in the radial and axial plane, as shown. On its radially outer side, i.e. its side away from the central axis X, the passage 108 is delimited by a wall 108b that may be approximately parallel to the casing 101 in the same radial and axial plane. Thus, since the casing 101 may converge slightly going downstream, the wall 108b may present an angle a (alpha) in this radial and axial plane that lies, for example, in the range 0° to 30° relative to the central axis X, thereby converging downstream towards the central axis X. The downstream angle of convergence 13 (beta) between the walls 108a and 108b may, by way of example, lie in the range 10° to 60°. The passage 108 opens out into a slot 108c in an outside surface of the vane 103. This slot 108c may be situated directly in the trailing edge 112 of the vane 103, even though other positions may also be envisaged in the proximity of the trailing edge 112, such as for example in the suction side or in the pressure side of the vane 103, between its maximum section and the trailing edge 112. In the embodiment shown, with a passage height h from an inside edge 2i to the outside edge 2e of the air passage 2 at the axial position of the slot 108c, a bottom edge 108i of the slot 108c is situated at a radial distance dᵢ from the inside edge 2i of the air passage 2 that lies, by way of example, in the range 80% to 95% of the passage height h, and a top edge 108s of the slot 108c is situated at a radial distance dₛ from the inside edge 2i of the air passage 2 that, by way of example, lies in the range 90% to 100% of the passage height h.

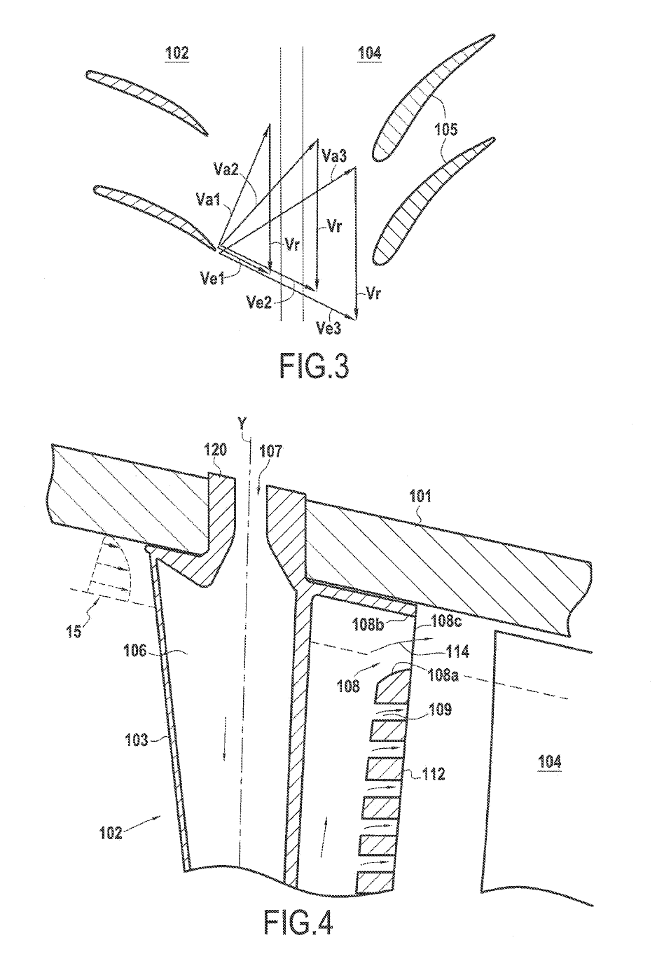

In operation, the hot air that is inserted into the cavity 106 through the inlet 107 passes through the cavity 106 to the outlet passages 108, 109. In so doing, the hot air, which may come from a takeoff point downstream at least from this compressor stage 100, heats the vane 103, thereby ensuring it is deiced, while also cooling itself. The outlet passage 108 thus injects an air jet 114 that is relatively cool, and thus dense, into the boundary layer 115 adjacent to the casing 101 through which the tips 104b of the blades 104 pass as they rotate, thereby energizing this boundary layer 115 upstream from the blades. FIG. 3 shows the effect of this acceleration of the boundary layer at the tips of the blades 104. In this diagram, arrows vₐ₁, vₐ₂, and vₐ₃ correspond to three apparent speed vectors at the blade tips, for a given speed of rotation vᵣ, but for increasing flow speeds vₑ₁, vₑ₂, and vₑ₃ in the boundary layer 115. It can thus be seen how the increase in the flow speed of the boundary layer 115, as a result of injecting the air jet 114, serves to reduce the angle of incidence at the blade tip, thereby avoiding local flow separations and the generation of tip clearance vortices.

Although in the embodiment shown in FIG. 2, the wall 108a is straight, it is also possible to envisage it being curved and convex, as in the embodiment shown in FIG. 4, in order to optimize the aerodynamics of the passage 108 and thus reduce head losses in the passage. The other elements in this figure are equivalent to those of the first embodiment and consequently they are given the same references. It is also possible to envisage having such internal cavities and/or an outlet passage suitable for injecting an air jet into the boundary layer in only a subset of the vanes of the stator.

Although the present invention is described with reference to specific embodiments, it is clear that various modifications and changes can be undertaken on these embodiments without going beyond the general ambit of the invention as defined by the claims. In addition, individual characteristics of the various embodiments mentioned may be combined in additional embodiments. Consequently, the description and the drawings should be considered in a sense that is illustrative rather than restrictive.

1. A compressor stage comprising at least:
a casing delimiting an air passage;
a stator comprising a plurality of guide vanes arranged radially around a central axis in the air passage; and
a rotor rotatable about the central axis relative to the stator and comprising a plurality of blades arranged radially around the central axis in the air passage downstream from the guide vanes, each blade of the plurality of blades extending from a blade root to a blade tip further away from the central axis than the blade root and presenting radial clearance between the blade tip and the casing;
wherein at least one guide vane of the plurality of guide vanes includes an internal cavity with a hot air inlet for deicing the at least one guide vane, and in that the internal cavity presents a first outlet passage towards a trailing edge of the at least one guide vane for injecting an air jet into a boundary layer adjacent to the casing upstream from the blades of the rotor.

2. The compressor stage according to claim 1, wherein, in an axial and radial plane, the first outlet passage is delimited towards the central axis by a surface that converges downstream towards the casing.

3. The compressor stage according to claim 2, wherein the surface delimiting the first outlet passage beside the central axis is curved and convex in the axial and radial plane.

4. The compressor stage according to claim 1, wherein, in an axial and radial plane, the first outlet passage is delimited away from the central axis by a surface that presents, relative to an axial direction, an angle of inclination in the range 0° to 30° towards the central axis downstream.

5. The compressor stage according to claim 1, wherein the first outlet passage converges downstream.

6. The compressor stage according to claim 5, wherein, in an axial and radial plane, the first outlet passage presents an angle of convergence in the range 10° to 60°.

7. The compressor stage according to claim 1, wherein the first outlet passage opens out in a slot in an outside surface of the at least one guide vane.

8. The compressor stage according to claim 1, wherein the hot air inlet is situated radially on the outside relative to the internal cavity, and the internal cavity presents a radial partition situated between the inlet and the first outlet passage and open at an end remote from the air inlet.

9. The compressor stage according to claim 1, wherein the internal cavity presents at least one other outlet passage opening out separately from the first outlet passage in the trailing edge of the guide vane in a position that is closer to the central axis than is the first outlet passage.

10. The compressor stage according to claim 9, wherein the first outlet passage presents a cross-section that is greater than the other outlet passage.

11. The compressor stage according to claim 1, wherein the guide vanes are of variable angle of incidence.

12. A compressor including a first stage according to claim 1.

13. A turboprop including a compressor according to claim 12.

14. A method of eliminating blade tip clearance vortices in a compressor stage according to claim 1, wherein a jet of air that has flowed through the internal cavity of the at least one guide vane in order to deice the at least one guide vane is injected upstream from the plurality of blades of the rotor and through the first outlet passage into a boundary layer adjacent to the casing upstream from the plurality of blades of the rotor and through which the blade tips pass, for the purpose of energizing the boundary layer.
